(19) United States
(12) Patent Application Publication
(10) Pub. No.: US 2009/0127726 A1
(43) Pub. Date: May 21, 2009

(54) System and Method for Molding Intraocular Lenses

(76) Inventors: John C. Spalding, Rochester, NY (US); Daniel P. Barrows, Rochester, NY (US)

Correspondence Address: Bausch & Lomb Incorporated, One Bausch & Lomb Place, Rochester, NY, 14604-2701, US

(21) Appl. No.: 11/943,937

(22) Filed: Nov. 21, 2007

(51) Int. Cl. B29D 11/00

(52) U.S. Cl. 264/1.7; 425/588

(57) ABSTRACT

Systems and methods for molding an intraocular lens (IOL) are disclosed. The system for making an intraocular lens comprises a mold insert and a spacer adapted to be positioned between the first and second portions of the mold insert. The method of making a dual-element intraocular lens comprises providing a mold insert including a spacer.

### BACKGROUND

1. Field of the Technology

At least one embodiment of the present invention relates generally to a molding system for making intraocular lenses (IOLs). More particularly, certain embodiments relate to a molding system having a collapsible portion which allows for ease of removal of the IOL from the tooling, and reduces the likelihood of damaging the IOL and molding system during the manufacturing process.

2. Discussion

Intraocular lenses (IOLs) have been manufactured using many different techniques including cast molding, lathing, and liquid injection molding (LIM). Using the LIM technique, a cold liquid lens forming material, for example a liquid silicone, is injected into a heated mold cavity of the desired configuration and allowed to cure. In particular, with regard to making a dual-element IOL having an anterior and posterior optical element, a three-piece mold is used which contains a removable mold insert. The mold insert is preferably connected to a handle to permit easier handling thereof. During the molding process, the mold insert occupies a volume between the anterior and posterior optical elements. The material is cured around the mold insert and within a two-cavity mold frame. The formed IOL may then be removed with the mold insert, from the two-cavity mold frame.

The formed IOL must then be carefully removed from around the mold insert to prevent damage to the IOL and/or the mold insert. While the LIM technique performs well for many reasons, certain aspects of the tooling system and production process may be improved. For example, because of the geometry of the mold insert and IOL, the IOL should be carefully removed from the mold insert, to reduce the likelihood of damage to the IOL and the mold insert. In certain embodiments, the IOL may contain one or more haptics which space the anterior and posterior optical elements from each other and assist in properly positioning the device in the eye. The haptics may be formed at the same time as the optical elements of the IOL, and may be made of a flexible material that allows them to flex in response to forces exerted by the eye's ciliary muscles. This in turn, allows the flexing of the optical elements. In IOLs comprising haptics, the IOL must be removed by carefully stretching the haptics such that the mold insert may pass through the space defined between the haptics. Therefore, it is desired to simplify the IOL removal process to allow for easier removal of the IOL from the mold insert, increased automation and efficiency of the IOL production process, and reduced likelihood of damage to the IOL, mold insert, and other system components.

### BRIEF SUMMARY

Certain aspects and embodiments disclosed herein provide an apparatus and methods for making an intraocular lens (IOL).

In accordance with a first aspect, a system for molding a dual-element intraocular lens having a first optical element and a second optical element is provided. The system comprises a mold insert comprising a first portion constructed and arranged to define an inwardly facing portion of a first optic cavity. The mold insert also comprises a second portion constructed and arranged to define an inwardly facing portion of a second optic cavity. The system also comprises a spacer adapted to be positioned between the first and second portions of the mold insert.

In accordance with an additional aspect, a system for making a dual-element intraocular lens is provided, comprising a mold insert configured to form at least one portion of an intraocular lens and to release the at least one portion of the formed intraocular lens.

In accordance with another aspect, a method of making a dual-element intraocular lens is provided, comprising providing a mold insert within a cavity to define an inwardly facing portion of a first optic cavity and an inwardly facing portion of a second optic cavity. The method also comprises injecting a lens forming material into the first optic cavity and the second optic cavity. The method also comprises collapsing the mold insert to permit movement of at least one of the inwardly facing portion of the first optic cavity and the inwardly facing portion of the second optic cavity.

Other advantages, novel features and objects of the invention will become apparent from the following detailed description of the invention when considered in conjunction with the accompanying drawings.

### BRIEF DESCRIPTION OF THE FIGURES

Certain illustrative embodiments are described below with reference to the accompanying figures in which:

FIG. 1 illustrates an example of a cross-sectional view of a system for molding a dual-element intraocular lens, in accordance with certain embodiments;

FIG. 2 illustrates another example of a cross-sectional view of a system for molding a dual-element intraocular lens, in accordance with certain embodiments; and

FIG. 3 illustrates another example of a cross-sectional view of a system for molding a dual-element intraocular lens, in accordance with certain embodiments.

Certain features or components of the illustrative embodiments of the system for making an intraocular lens shown in the figures may have been enlarged, distorted or otherwise shown in a non-conventional manner relative to other features or components to facilitate a better understanding of the novel systems and methods disclosed herein. It will be recognized by the person of ordinary skill in the art, given the benefit of this disclosure, that the systems and methods disclosed herein, can be used in any orientation relative to gravity and suitable orientations will be readily selected by the person of ordinary skill in the art, given the benefit of this disclosure.

### DETAILED DESCRIPTION

Certain embodiments of the systems and methods disclosed herein will be recognized by the person of ordinary skill in the art, given the benefit of this disclosure to provide systems and methods for producing an intraocular lens (IOL) in a more simplified, reliable, and cost-effective manner. In particular, systems for making dual-element IOLs are provided that simplify the removal of the IOL from the tooling system, and may better ensure the integrity of the product and consistency of the manufacturing process. The systems and methods of certain embodiments disclosed herein will reduce the complexity and the human error involved with removing the IOL from the system, and additionally put less stress on the formed IOL, in part, because portions of the IOL may no longer be stretched during the removal. The current systems for injection molding IOLs may be adapted to include the present technology.

As discussed above, IOLs are generally manufactured through mold injection processes. For example, IOLs may be manufactured by mold injection processes such as those described in Graney et al. in United States Patent Publication No. 2006/0069431, filed Mar. 30, 2006, which is incorporated herein by reference in its entirety. In one embodiment, a dual-element IOL having a first optical element and a second optical element may be injection molded in a mold cavity having a removable mold insert. This mold insert may be made of a metal and may be centrally located between a first and a second cavity block of a two-cavity mold frame. The first optical element is formed between the first cavity block and a portion of the mold insert. The second optical element is formed between the second cavity block and another portion of the mold insert. Additionally, one or more haptics, may connect the first and second optical elements. The one or more haptics may be integrally formed with the optical elements by the mold insert and first and second cavity blocks. A lens forming material, for example silicone, may be injected into the mold frame as a liquid, and allowed to cure to form some or all portions of the IOL. The lens forming material may also be selected from conventional lens materials, for example, polymethylmethacrylate, glass, acrylic, or the like, provided that visual clarity, refractive ability, and biocompatibility are all maintained.

The two-cavity mold frame may then be opened and the mold insert may be removed. The IOL may remain in place around the mold insert as it is removed from the cavity blocks. The IOL may then be removed from the mold insert by carefully stretching it to allow the mold insert to pass between an opening defined between the one or more haptics. Extra care must be taken to ensure that the IOL and the mold insert do not become damaged during the removal process. The mold insert may then be replaced between the cavity blocks to mold another IOL. The system components are manufactured to withstand repeated molding cycles.

The present technology provides systems and methods for molding an IOL that may be manufactured by injection molding. This technology will allow for more streamlined manufacturing of IOLs. For example, this technology may allow simplified and more efficient removal of the IOL product from the system, and additionally may provide more consistent product, and increased lifetime of the system components. These advantages of the present invention overcome the noted deficiencies of the current systems and methods used for making IOLs.

As used herein, the term “mate” or “mating” may describe any manner of connecting or joining two or more components together. The term “mate” or “mating” may describe any mechanical, thermal, or chemical process that may connect or join two or more components together. In the embodiments disclosed herein, the term “mate” or “mating” may mean adhering, clamping, snapping, hinging, pivoting, interlocking, or otherwise connecting two components. For example, two or more components of the mold insert, or the mold insert and the spacer may be adhered, clamped, snapped, hinged, pivoted, or interlocked together. In some embodiments, the mating may be temporary.

The system for making an IOL may comprise a mold insert configured to form at least one portion of the IOL. The mold insert may also be configured to release the at least one portion of the formed IOL. As used herein, the term “release” or “releasing” may describe any manner of setting an entity free from being held in place, restrained, or confined. The term “release” or “releasing” may describe any mechanical, thermal or chemical process that may free an entity. In the embodiments disclosed herein, the them “release” or “releasing” may describe any process that may free one component from another component. For example, all or a portion of an IOL may be freed from being held in place or confined from a mold insert. In certain examples, all or a portion of an IOL may be freed from being held in place or confined from a mold insert by collapsing at least a portion of the mold insert. The collapsing may be accomplished by removal of an element that positions the mold insert in place during the molding process.

The system for molding an IOL may comprise a mold, and a spacer. The mold insert may comprise a first portion constructed and arranged to define an inwardly facing portion of a first optic cavity. The mold insert may also comprise a second portion constructed and arranged to define an inwardly facing portion of a second optic cavity. The first and second portions of the mold insert may be movable relative to one another. The system may also comprise a spacer adapted to be positioned between the first and second portions of the mold insert.

In accordance with certain embodiments, a system for molding a lens is disclosed. The system may be used to mold an IOL. In certain examples, the system may be used to mold a dual-element IOL. The system may be also be used to mold an accommodative IOL. The system may comprise various components that may take part in the mold injection process. For example, the system may comprise electronic controls, heating elements for curing the IOL, cooling elements, and an injection nozzle for injecting the lens forming material into the mold cavity.

In accordance with certain embodiments, the system for molding an IOL may comprise a mold insert. The mold insert may be any size or shape that may provide, in part, a boundary for defining an optic cavity of the injection molding system. The mold insert may include portions that define at least a portion of a first optic cavity and at least a portion of the second optic cavity. The mold insert may have surfaces that form a portion of a first optical element. The mold insert may also have surfaces that form a portion of a second optical element. In certain examples, the mold insert may have surfaces that form an inwardly facing portion of a first optical element. Likewise, the mold insert may have surfaces that form an inwardly facing portion of a second optical element. The mold insert may have surfaces that are capable of forming optical grade optical elements to use in IOLs. Additionally, in certain embodiments, the mold insert may have surfaces that form one or more haptics. The cavities that form one or more haptics may be in fluid communication with the cavities that form the first and second optical elements of the IOL.

The mold insert may be used to form various portions of dual-element lens configurations. For example, the mold insert may be used to form, in part, a concavo-convex shaped lens configuration. In other examples, the mold insert may be used to form concavo-planar, concavo-convex, convex-concavo, or bi-convex lens configurations. Any one of the concave or convex lens surfaces may be spherical or aspherical. The lenses may comprise diffractive, multifocal, or torroidal optics. In certain examples, the first optical element may be an anterior optical element, while the second optical element may be a posterior optical element. In certain other examples, there may be more than two elements in the optical system.

The mold insert may comprise two or more components. One or more of these components may be capable of collapsing within a formed IOL. A first component of the mold insert may define an inwardly facing portion of a first optic cavity. A second component of the mold insert may define an inwardly facing portion of a second optic cavity. The first component of the mold insert may have a surface that forms a portion of a first optical element. The second component of the mold insert may also have a surface that forms a portion of the second optical element. In certain examples, the first component of the mold insert may have surfaces that form an inwardly facing portion of a first optical element. Likewise, a second component of the mold insert may have surfaces that form an inwardly facing portion of a second optical element. The first and second component of the mold insert may have surfaces that are capable of forming optical grade elements to use in IOLs.

In certain embodiments, a two-piece mold insert may be used in the system, wherein one component may produce a portion of the first optical element, and wherein a second component may produce a portion of the second optical element. Upon forming an IOL, the one or more components of the mold insert may be in communication with another element of the system to collapse.

In certain other embodiments, a four-piece mold insert may be used in the system. For example, the mold insert may comprise a component for molding a first optical element, and a component for molding a second optical element. These portions may have an area that is the same or substantially similar as the area of the optical elements. Additionally, the mold insert may comprise two other components that are configured with another element of the system to collapse. In certain examples, the components configured to collapse may define an inwardly facing portion of the one or more haptics.

The portions of the mold insert may be assembled by mating or otherwise joining the portions in various ways. The portions may be mated by adhering, clamping, snapping, hinging, pivoting, interlocking, or otherwise connecting two portions. For example, a first portion of a mold insert may be hinged to a second portion of the mold insert. Upon removing the spacer that is positioned between the two portions, the portions may collapse inwardly, pivoting at the hinged end. The mold insert may hold a cured IOL in place in the molding system. This may occur in conjunction with another element discussed in detail below.

The mold insert may be configured to be inserted and removed from a cavity block of the system. In setting up the system to mold an IOL, the mold insert may be placed in a paddle core prior to being placed in the cavity block. The paddle core may have an annular portion in which the mold insert resides during the mold injection process. The mold insert may mate with the annular portion of the paddle core. This may be accomplished by an adhesive, a friction fit between the two pieces, mechanical interlocking, or the like. The paddle core may also have a handle to assist in alternately inserting and removing the mold insert from the cavity blocks. The mold insert may also assist in protecting the formed IOL when transporting the formed IOL out of the cavity mold.

In accordance with certain embodiments, the system may comprise an additional element to assist in forming the IOL. The element may be in communication with the mold insert, and together they may provide an aspect of the system for forming the internal portion of the IOL. The element is a spacer that may fit between portions of the mold insert. In some embodiments, the spacer may be of any size or shape to fit within the mold insert so that it is a section or segment of the mold insert. The spacer may be a segment, section, wedge, pin, shim, or the like. The spacer may be placed approximately longitudinally within the mold insert and may be positioned approximately parallel to the portions of the mold insert that define the first and second optic cavity. The spacer may be a separate part, or may be formed integrally with the mold insert. The spacer may fit between portions of the mold insert, but may not necessarily extend the entire length of the mold insert.

The spacer may be present during the injection molding process, and removable to assist in releasing the IOL from the system. The spacer may be at least partially removed from the mold insert. The removal may be accomplished without disturbing the formed IOL. Removing the spacer allows at least a portion of the mold insert to collapse into the void created by the removal. Additionally, upon removal of the spacer, the volume of the mold insert is reduced. The collapsing of the mold insert may be desired due to the shape of the optical elements and/or haptics, which create a restriction. For example, the geometry of the mold insert may be such that it is thicker at a certain point than other points of the mold insert. Upon removal of the IOL from the mold insert, this thickness may be greater than a portion of the space between the optical elements of the IOL. This difference in thicknesses causes difficulty in smoothly removing the IOL from the mold insert, and is described as a restriction between the IOL and the mold insert. The restriction may cause the IOL, or more specifically, the haptics and/or optical elements, to stretch during removal of the IOL from the mold insert. Therefore, the collapsing of the mold insert may detach the formed intraocular lens from the mold insert. For example, depending on the geometry of the spacer, which, upon withdrawal, allows for the collapsing of the mold insert, a void may form between the mold insert and the first and/or second optical elements. Alternatively, depending on the geometry of the spacer, which, upon withdrawal, allows for the collapsing of the mold insert, a void may form between the mold insert and one or more haptics. In certain examples, due to the geometry of the spacer, upon withdrawal, a void may form between the mold insert and the first and/or second optical elements, and the mold insert and one or more of the haptics. In certain embodiments, the volume of the void may never be more than the volume of the spacer.

As discussed above, the void created by the collapsing of the mold insert reduces the restriction between the mold insert and the IOL, and may release at least a portion of the IOL. Depending on the geometry of the spacer, the mold insert may collapse in various configurations. In certain examples, the geometry of the spacer may be such that the mold insert collapses to reduce the restriction created between the mold insert and the haptic. In certain other examples, the geometry of the spacer may be such that the mold insert collapses to reduce the restriction created between the mold insert and a first and second optical element of the IOL. In some examples, the geometry of the spacer may be such that the mold insert collapses to reduce the restriction created between both the mold insert and the first and second optical elements of the IOL, and the mold insert and one or more of the haptics.

As suggested above, the spacer may be of various geometries, and may be constructed to be removed without disturbing the mold insert or the formed intraocular lens. The spacer may be tapered so that the portion of the spacer removed first from the mold insert is the widest portion, with reference to the plane of the optical elements. The spacer may also be tapered so that the portion of the spacer removed first from the mold insert is the widest portion, with reference to the plane of the haptics. In other examples, the spacer may not be tapered, and instead the spacer may be a consistent width throughout a length of the mold insert. It will be within the ability of the person of ordinary skill in the art, given the benefit of this disclosure, to select or to design suitable geometries, sizes and materials for construction of the spacer disclosed herein to be compatible with the mold insert.

The spacer may be made of one or more components. If the spacer is made of more than one component, they may be of any size or shape so that they may be assembled to fit within the mold insert, and to be compatible with the mold insert. The more than one component may provide easier removal of the components to collapse the mold insert.

The spacer may be removed from the system in any manner to allow the formed intraocular lens to go undisturbed. The spacer may be removed manually, or with the assistance of an automated device. The spacer may be removed in one or more parts. In certain embodiments, the spacer may be removed from one end of the system. Additionally, when the spacer comprises more than one component, the spacer may be removed from more than one part of the system. For example, one component may be removed from one end, while another component may be removed from another end. The removal of more than one component may occur sequentially, or simultaneously. The spacer may also be removed from more than one mold insert, wherein the system may mold more than one intraocular lens in a given cycle.

The system for molding an IOL may also comprise a two-cavity mold frame. The two-cavity mold frame may comprise a first cavity block and a second cavity block that may define a portion of the first optic cavity and the second optic cavity. The first cavity block may be constructed and arranged to define an outwardly facing portion of the first cavity, while the second cavity block may be constructed and arranged to define an outwardly facing portion of the second cavity. The first and second cavity blocks may have surfaces of optical grade quality that define the outwardly facing portions of the first and second cavities. The cavity blocks may work with the mold insert to define the shapes, sizes, and configurations of the optic cavities that form the optical elements. The cavity blocks may mate with portions of the mold insert to create the optic cavities. The cavity blocks may also be constructed and arranged to define an outwardly facing surface of one or more haptics, and may mate with portions of the mold insert to create the haptic cavities.

In accordance with certain embodiments, the system for molding an intraocular lens may also comprise a separate element that may collapse the mold insert or assist in collapsing the mold insert. This element may be a sleeve constructed and arranged to collapse the mold insert. More specifically, in certain embodiments, the sleeve may be a separate element used to collapse the mold insert or to assist in collapsing the mold insert, when, upon removing the spacer, the mold insert does not collapse independently. The sleeve may be triggered when the mold insert does not collapse independently. The sleeve may be any shape that allows it to surround a portion of the paddle core.

With regard to the system in operation, the method of making a dual-element intraocular lens is provided. The method may comprise providing a mold insert within a cavity to define an inwardly facing portion of a first optic cavity and an inwardly facing portion of a second optic cavity, the mold insert including a spacer. The method may also comprise injecting a lens forming material into the first optic cavity and the second optic cavity to form a first optical element and a second optical element, the spacer being located between the optical elements. The method may also comprise collapsing the mold insert to permit movement of the inwardly facing portion of the first optic cavity and the inwardly facing portion of the second optic cavity.

In accordance with certain embodiments, upon injection of the lens forming material into the two-cavity mold, the first and second optic cavities may be filled with the lens forming material, which may be allowed to cure to ultimately form an optical element. In certain examples, the haptic cavities of the IOL may also be filled with lens forming material. The lens forming material may be allowed to cure, and the IOL may be formed. Upon formation of the intraocular lens, the spacer may be removed from the mold insert. This will allow the mold insert to collapse inwardly. Depending on the geometry of the spacer, the mold insert may collapse so as to allow a gap to form between the mold insert and the first and/or second optical elements. In addition or alternatively, the mold insert may collapse so as to allow a gap to form between the mold insert and one or more haptics. The spacer may be removed before the mold insert is removed from the two-cavity mold. Once the spacer has been removed, allowing portions of the mold insert to collapse, the mold insert may be removed from the cavity blocks. Subsequently, the cavity blocks may be opened, and the formed IOL may be removed. The haptics may be made from the same or different material than the optical elements. The haptic and optical elements may be made in the same or different injection steps.

The spacer may also be removed after the mold insert is removed from the two-cavity block. Upon opening the two-cavity block, the handle of the paddle core may be used to assist in moving the mold insert, with the formed IOL still in contact with the mold insert. After removing the paddle core from the system, the spacer may be removed, allowing the mold insert to collapse, and releasing the formed IOL from the mold insert. This allows the IOL to then be removed from the mold insert. The intraocular lens may then be post-injection molding processed according to standard methods. For example, the intraocular lens may be processed further in a polishing step to clean up any extra lens material, such as vestiges, from the mold injection process.

The material used for the components of the system may be any material suitable for injection molding, given the benefit of this disclosure, such that the material may withstand the temperatures and pressures of the injection molding process, and may also be compatible with the lens forming material. The material used for one component may be the same or different as the material used for another component. For certain components, such as the spacer and the mold insert, it may be beneficial that the components have the same or similar chemical and physical properties (e.g., thermal expansion coefficients and heat transfer coefficients), so that they are compatible with one another. The material may include, but not be limited to, metals and plastics. For example, the mold insert may be a diamond turned metal. The components of the system may be made of a thermally resistant plastic such as ULTEM™ resin polymer. Optical surfaces, such as of the mold insert or cavity blocks, may be formed by Electrical Discharge Machining (EDM) or diamond turned metal of high optical quality and thermal conductivity, such as a copper nickel alloy. It will be within the ability of the person of ordinary skill in the art, given the benefit of this disclosure, to select or to design suitable shapes, sizes and materials for construction of the system components disclosed herein.

The injection molding process may be performed manually or by automatic processes. For example, the removal of the various components of the system, including the spacer and the mold insert, may be performed manually or by automatic processes. Additionally, the system may be constructed and arranged to produce more than one intraocular lens during one cycle. For example, one spacer may be within more than one mold insert, with the mold inserts aligned along the one spacer.

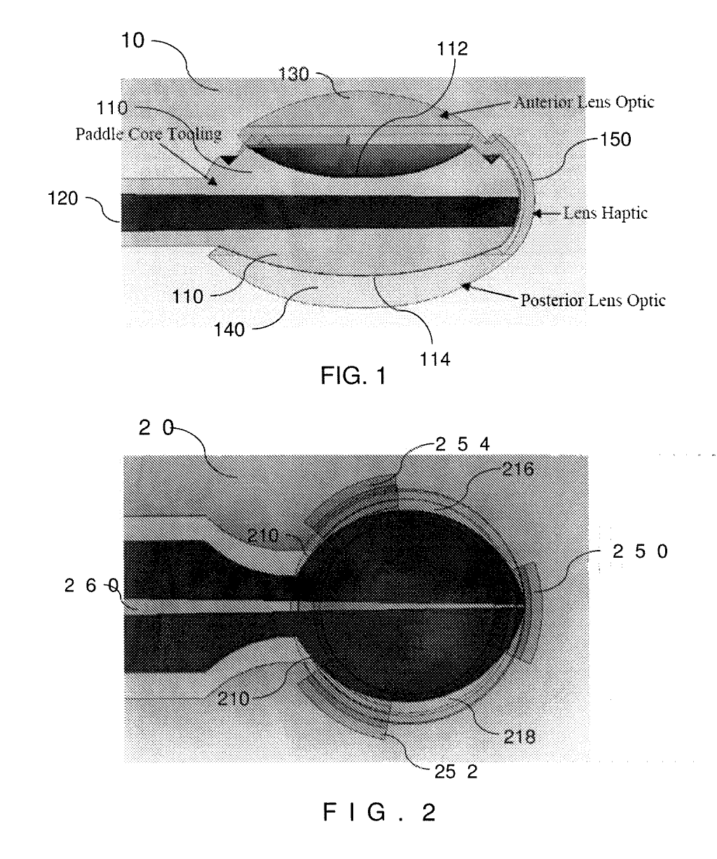

FIG. 1 illustrates a cross-sectional view of one embodiment of a system for molding an intraocular lens 10. Mold insert 110, in two components, has spacer 120. Spacer 120 is configured to be compatible with mold insert 110 such that when they are fitted together, they form a cohesive unit to fill the interior cavity between the optical elements and haptics. Mold insert 110 may be of any size and shape suitable for defining the inwardly facing portion of a first optic cavity and an inwardly facing portion of a second optic cavity. First optic element 130 and second optical element 140 may be formed on opposite sides of mold insert 110. As illustrated in FIG. 1, first optical element 130 is an anterior optical element, while second optical element 140 is a posterior optical element. Surface 112 of mold insert 110 may form an optical surface of first optical element 130. Additionally, surface 114 of mold insert 110 may form an optical surface of a second optical element 140. Optical element 130 and optical element 140 may be connected by lens haptic 150. Although spacer 120 may be any suitable size and shape to support the mold insert during the injection process and allow for collapsing of mold insert 110 upon removal of spacer 120, as shown in FIG. 1, spacer 120 is not tapered, and fills the space between the portions of mold insert 110, supporting the portions to form an IOL.

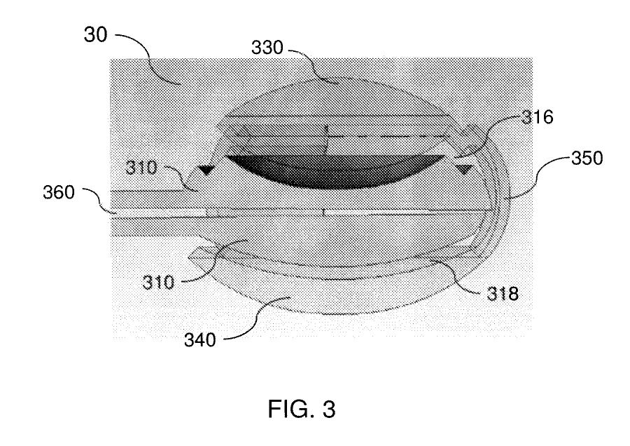

FIGS. 2 and 3, illustrate cross-sectional views of various systems for molding an intraocular lens in accordance with certain embodiments. Both FIGS. 2 and 3 illustrate the system with the spacer removed. In FIG. 2, mold insert 210, in two components, is shown partially collapsed inwardly, away from haptics 252 and 254. In this embodiment, in the collapsed state, voids 216 and 218 are created between each portion of mold insert 210 and haptics 252 and 254. Haptic 250 stays in contact with mold insert 210. As shown, the spacer may be in the form of a wedge that is widest at end 260 from which the spacer is removed.

In FIG. 3, mold insert 310 is shown partially collapsed inwardly, away from optical elements 330 and 340. In this embodiment, in the collapsed state, voids 316 and 318 are created between each portion of mold insert 310 and optical elements 330 and 340. Haptic 350 remains in contact with mold insert 310. As shown, the spacer may be in the form of a wedge that is widest at end 360 from which the spacer is removed.

Although the mold injection devices and methods been described above in terms of certain examples and embodiments, various alterations, modifications, substitutions, additions and improvements will be readily apparent to the person of ordinary skill in the art, given the benefit of the disclosure. Such alterations, modifications, substitutions, additions and improvements are intended to be within the scope and spirit of the mold injection devices and methods disclosed herein. It is also intended that the indefinite articles “a” and “an,” as used above and in the appended claims, mean one or more of the articles which they modify, and that the terms “include,” “including” and “having” are interchangeable with the open ended term “comprising.” Only the transitional phrases “consisting of” and “consisting essentially of,” are closed or semi-closed transitional phrases, respectively, with respect to the claims.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific embodiments of the invention. It is therefore to be understood that the embodiments described herein are presented by way of example only and that, within the scope of the appended claims and equivalents thereto, the invention may be practiced otherwise than as specifically described.

What is claimed is:

1. A system for molding a dual-element intraocular lens having a first optical element and a second optical element comprising:
a mold insert comprising a first portion constructed and arranged to define an inwardly facing portion of a first optic cavity, and comprising a second portion constructed and arranged to define an inwardly facing portion of a second optic cavity, the first and second portions being movable relative to one another; and
a spacer adapted to be positioned between the first and second portions of the mold insert.

2. The system of claim 1, further comprising a first cavity block constructed and arranged to define an outwardly facing portion of the first optic cavity and a second cavity block constructed and arranged to define an outwardly facing portion of the second optic cavity.

3. The system of claim 2, wherein the first and second portions of the mold insert are hinged.

4. The system of claim 2, wherein the spacer is constructed and arranged to allow the first and second portions of the mold insert to collapse.

5. The system of claim 4, wherein the first and second cavity blocks are constructed and arranged to define an outwardly facing surface of a haptic of the intraocular lens.

6. The system of claim 5, wherein the mold insert is constructed and arranged to define an inwardly facing surface of the haptic of the intraocular lens.

7. The system of claim 6, wherein the spacer is positioned between the first and second portions of the mold insert.

8. The system of claim 7, wherein the spacer is constructed and arranged so that removal of the spacer enables collapsing of the mold insert to reduce the restriction created between the mold insert and the haptic.

9. The system of claim 6, wherein the spacer is constructed and arranged so that removal of the spacer enables collapsing of the mold insert to reduce the restriction created between the mold insert and at least one of the first optical element and the second optical element of the intraocular lens.

10. The system of claim 8, wherein the spacer is further constructed and arranged to collapse the mold insert when removed to reduce the restriction created between the mold insert and at least one of the first optical element and the second optical element of the intraocular lens.

11. A system for making a dual-element intraocular lens comprising:
a mold insert configured to form at least one portion of an intraocular lens and to release the at least one portion of the formed intraocular lens.

12. The system of claim 11, wherein the mold insert is configured to form an inwardly facing portion of the intraocular lens.

13. The system of claim 12, further comprising a cavity block configured to form an outwardly facing portion of the intraocular lens.

14. The system of claim 13, further comprising a spacer constructed and arranged to separate portions of the mold insert.

15. A method of molding a dual-element intraocular lens comprising:
providing a mold insert within a cavity to define an inwardly facing portion of a first optic cavity and an inwardly facing portion of a second optic cavity;
injecting a lens forming material into the first optic cavity and the second optic cavity to form a first optical element and a second optical element; and
collapsing the mold insert to permit movement of at least one of the inwardly facing portion of the first optic cavity and the inwardly facing portion of the second optic cavity.

16. The method of claim 15, wherein the inwardly facing portion of the first optic cavity and the inwardly facing portion of the second optic cavity are optical grade surfaces.

17. The method of claim 15, wherein the step of collapsing the mold insert comprises removing a spacer.

18. The method of claim 15, further comprising providing a first cavity block to define an outwardly facing portion of the first optic cavity, and providing a second cavity block to define an outwardly facing portion of the second optic cavity.

19. The method of claim 18, further comprising removing the mold insert from at least one of the first cavity block and the second cavity block.

20. The method of claim 19, wherein the step of providing a mold insert further comprises providing the mold insert to define an inwardly facing portion of a haptic cavity.

21. The method of claim 20, wherein the steps of providing the first cavity block and the second cavity block comprises providing the first cavity block and the second cavity block to define an outwardly facing portion of the haptic cavity.
